(19) United States
(12) Patent Application Publication
(10) Pub. No.: US 2013/0090954 A1
(43) Pub. Date: Apr. 11, 2013

(54) MISTAKEN CONVICTION INSURANCE PRODUCT AND RELATED SYSTEM AND METHODS

(71) Applicant: NET5 SOLUTION ENTERPRISES, INC., Merritt Island, FL (US)

(72) Inventor: William A. Harding, Cocoa Beach, FL (US)

(73) Assignee: NET5 SOLUTION ENTERPRISES, INC., Merritt Island, FL (US)

(21) Appl. No.: 13/647,644

(22) Filed: Oct. 9, 2012

Related U.S. Application Data
(60) Provisional application No. 61/544,894, filed on Oct. 7, 2011.

(51) Int. Cl. G06Q 40/08

(52) U.S. Cl. 705/4

(57) ABSTRACT

An insurance product is presented that may cover the risk of compensating an exoneree for damages resulting from mistaken conviction The mistaken conviction insurance product may include a coverage amount, a premium amount, and a trigger of coverage payout. The trigger of coverage payout may be the overturning of a mistaken conviction. The coverage amount may compensate the exoneree for damages such as injury and expenses resulting from incarceration. The premium amount may be calculated based on factors that may include coverage payout elections and triggering event likelihood. The insurance product may be of the liability policy type to cover the person or entity liable to an exoneree, or of a first-person type to cover an insured's risk of mistaken conviction. A business method for offering and issuing a mistaken conviction insurance policy, and a computer-based system for facilitating the same, are also disclosed.

### RELATED APPLICATIONS

This application claims the benefit of U.S. Provisional Patent Application Ser. No. 61/544,894 titled Mistaken Conviction Insurance filed on Oct. 7, 2011, the entire contents of which are incorporated herein by reference.

### FIELD OF THE INVENTION

The present invention relates to the field of liability insurance and, more specifically, to insuring the risk of mistaken conviction in a criminal proceeding, and associated methods.

### BACKGROUND OF THE INVENTION

According to data collected by The Innocence Project, hundreds of prison inmates have been exonerated (absolved from blame for a fault or wrongdoing) in the United States of America since 1989. In most of those cases, DNA testing was used to establish the innocence of the exoneree. However, in terms of financial support or social services after leaving prison, many exonerees receive little or no help from the system that failed them.

The difficulty of reentering society after conviction and subsequent incarceration is profound, and can lead to devastating problems for an exoneree. The typical exoneree's assets are often depleted, likely having been spent on legal fees in an attempt to avoid and/or overturn ones conviction. Most exonerees struggle to find housing and work, and many bear the economic weight of a conviction on their record for years before they are officially cleared.

Exoneration results from a finding of mistaken conviction, but not necessarily wrongful conviction. Wrongful conviction is based on “offense.” For example, in wrongful conviction, misconduct by public officials and violations of a defendant's rights take place between the initiation of the criminal process (pre-conviction) and the time of the conviction (peri-conviction). Mistaken conviction is based on “occurrence.” Mistaken conviction occurs when a criminal justice system incorrectly finds an innocent person guilty of an alleged crime (peri-conviction) and continues when a court subsequently hands down and carries out a sentence for that crime (post-conviction). Note that wrongdoing (“offense”) on the part of law enforcement or public officials is not required, but may be present, in a mistaken conviction.

An exoneree has few options for pursuing compensation, because prosecutorial immunity prevents an exoneree from bringing suit against prosecutors and law enforcement officials who committed no prosecutorial wrongdoing but nonetheless convicted the wrong person. The most common approach to providing financial support and/or service assistance to exonerees is passage of legislation that draws from public funds to provide some form of ex gratia compensation for exonerees. The Innocence Project reports that such compensation statutes are in place in the federal government, the District of Columbia, and 27 states. However, such legislation is not uniform in its implementation nationwide, and many laws fall short of helping exonerees recover from the injustice they suffered and the years of freedom they lost.

For example, not all state legislatures have adopted a compensation minimum of up to $50,000 per year of incarceration, with up to an additional $50,000 for each year spent on death row, in keeping with the federal standard created through the Innocence Protection Act of 2004. Also, some states opt to compensate the exonerees only via “private compensation bills” that require exonerees to mount costly and demanding campaigns to justify payment by the government. Other state laws prohibit compensation to those deemed to have “contributed” to their convictions, potentially denying justice to exonerees who were coerced, explicitly or implicitly, into confessing or pleading guilty to crimes they did not commit. Some state laws prevent compensation of individuals with unrelated felony convictions.

In cases where prosecutorial misconduct is present, wrongful conviction can lead to civil rights lawsuits by exonerees seeking compensation from state and local governments and public officials, sometimes resulting in multimillion-dollar jury verdicts and settlements. Whether such compensation comes as a jury award or as a statutory mandate, payment commonly is drawn from taxpayer funding. Consequently, these compensation approaches require the taxpaying public not only to fund its judicial system's successful operations, but also to assume liability for its judicial system's failures.

In very limited circumstances relating specifically to wrongful conviction, liability insurance has been used to compensate exonerees. Specifically, insurance policies such as Comprehensive General Liability (CGL), Public Official Liability (POL), and Law Enforcement Liability (LEL) may be available to cover qualifying personal and advertising injury related specifically to wrongful conviction. However, in a wrongful conviction scenario, payout of CGL, POL, and LEL coverage typically is triggered by pre-conviction and peri-conviction offenses and violations of rights.

Post-conviction injuries and expenses resulting from a wrongful conviction (including incarceration during the policy period) are insufficient to trigger coverage in existing liability policies. Furthermore, insurance policies like CGL, POL, and LEL do not cover occurrence-based injuries and expenses resulting from mistaken conviction, neither peri-conviction nor post-conviction. Simply put, exoneration by its occurrence alone will not trigger payout of coverage in existing liability policies.

Accordingly, there is a need for improved methods and systems for providing timely and adequate financial support and social services to the mistakenly convicted that compensate for post-conviction injuries and expenses, while at the same time minimizing the potential cost to the taxpaying public.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the foregoing in mind, one of the many objects of the present invention is to provide a mistaken conviction insurance product to manage the risk that a person convicted of a crime and sentenced to prison may be subsequently exonerated. The mistaken conviction insurance product may advantageously provide prompt and adequate compensation to exonerees, and/or coverage to persons or entities liable to exonerees. It is further an object of the present invention to compensate exonerees in cases whereby prosecutorial immunity shields government officials from legal claims stemming from other than wrongful prosecution. It is further an object of the present invention to create an insurance-centric exoneree compensation solution that is an alternative to statutory, taxpayer-funded programs. It is further an object of the present invention add market-based motivation to solving the problem of exoneree compensation in a way that overcomes the disincentive posed by the historically low numbers of exonerations. It is further an object of the present invention to provide convicted criminals with access to financial means to incentivize attorneys to take on cases for exoneration.

These and other objects, features and advantages according to embodiments of the present invention are provided by an insurance product that may include an insurance coverage amount offered by an insurer, a premium amount required by the insurer as consideration for the insurance coverage amount, and a trigger event recognized by the insurer for payout of the insurance coverage amount. The trigger event may be an overturning of a mistaken conviction. The premium amount may be based at least in part on the insurance coverage amount, a payout election, a payment election, and a risk of the trigger event occurring.

More particularly, the risk of the trigger event occurring may be based on actuarial criteria that may be of a type that is a convicted factor or a conviction factor. Convicted factors may include a convicted's prior criminal record, age upon conviction, gender, and race. Conviction factors may include the strength of evidence used to convict, the trial type, the trial forum, and the nature of the alleged crime.

The payout election may be of a type that is a lump-sum payout, an installment payout, and/or a periodic annuity payout. The payment election may be of a type that is a single payment, a flexible payment, and/or a modal payment. The insurance coverage amount may be based on the insurer's obligation to compensate a convicted.

The mistaken conviction insurance product may be a liability type policy, under which the insurer's obligation may be to an insured that may be liable to an exoneree. The insurer's obligation may include a duty to pay to defend the insured against a liability claim by an exoneree. The insurer's obligation may include a duty to reimburse the insured for legal defense expenses stemming from a liability claim by an exoneree. The insurer's obligation may include a duty to pay to settle a liability claim by an exoneree. The insurer's obligation may be to indemnify liability of the insured for injuries and expenses borne by an exoneree. The injuries may include incarceration of an exoneree. The expenses may include the cost to treat a medical condition resulting from incarceration of an exoneree and a cost to reward the securing of evidence leading to overturning the conviction of an exoneree. The insurer may have an obligation to comply with statutory compensation guidelines.

The mistaken conviction insurance product may be a first-person type mistaken conviction insurance policy, under which the insurer's obligation may be to an exoneree as the insured. The insurer's obligation may include a duty to reimburse an exoneree for legal defense expenses. The insurer's obligation may include a duty to payout coverage for damages resulting from injuries and expenses borne by an exoneree. The injuries may include incarceration of the exoneree, loss of income by the exoneree, and damage to the reputation of the exoneree. The expenses may include a cost to treat a medical condition resulting from incarceration of an exoneree, a cost to reward the securing of evidence leading to overturning the conviction of an exoneree, and a cost for rehabilitation services. The insurer's obligation may include a duty to seek reimbursement for payout to an exoneree from a liable party and an insurer of the liable party.

The present invention may also include a method by which an insurer may establish a mistaken conviction insurance policy with a subject insured, and may execute the terms of that policy in the event the subject of the insurance policy is exonerated. The method may include steps for offering to sell a mistaken conviction insurance product, and for issuing the mistaken conviction insurance product upon receipt of the premium amount. The method may include calculating the premium amount based on receiving a payout election, receiving a payment election, assessing a risk of a trigger event occurring, and determining an insurer obligation should the trigger event occur. The method may also include paying the insurance coverage amount as a consequence of the trigger event occurring.

The present invention may also include system for processing the method steps above to assess, price, and provision the insurance product above. The system may be a computer-based system to calculate mistaken conviction insurance policy premiums based on policy elections by the insured and actuarial criteria related to the criminal conviction.

### BRIEF DESCRIPTION OF THE DRAWINGS

FIG. 1 is a hierarchical chart of liability policy characteristics for mistaken conviction insurance product according to an embodiment of the present invention.

FIG. 2 is a hierarchical chart of first-person policy characteristics for mistaken conviction insurance product according to an embodiment of the present invention.

FIG. 3 is a flowchart illustrating a method aspect of an embodiment of the present invention for assessing, pricing, and provisioning of a mistaken conviction insurance policy.

FIG. 4 is a schematic organizational diagram of a computer-based system for processing the method of FIG. 3.

FIG. 5 is a block diagram illustrating the insurer server component of the computer-based system of FIG. 4.

FIG. 6 is a block diagram illustrating a diagrammatic representation of a machine in the example form of a computer system according to an embodiment of the present invention.

### DETAILED DESCRIPTION OF THE PREFERRED EMBODIMENT

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

The present disclosure relates to a system and method for the offering and issuing of mistaken conviction insurance. However, it is understood that the following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

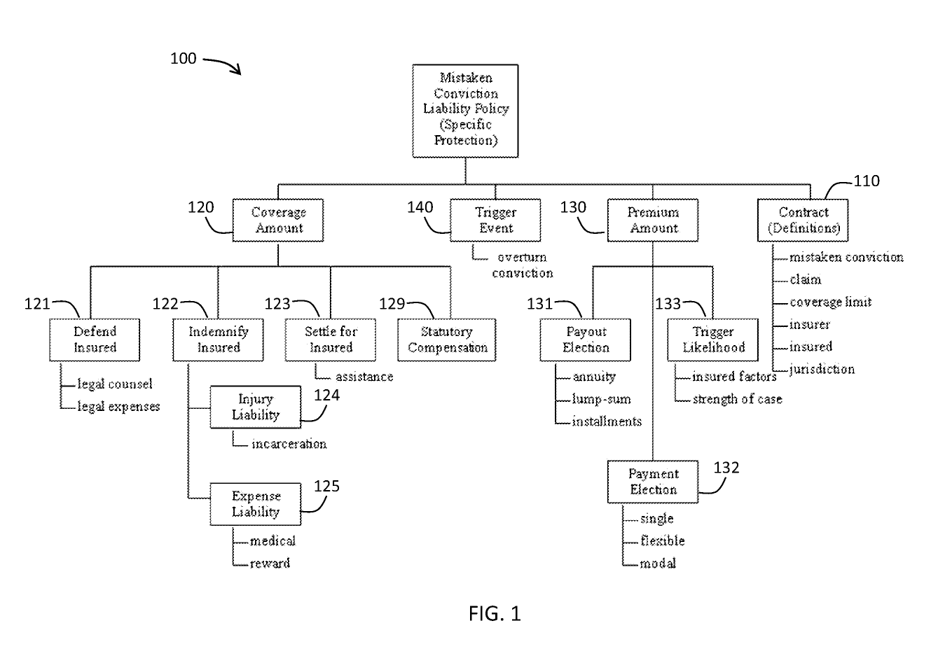

Referring now to FIG. 1, general characteristics of a liability policy embodiment are shown. A mistaken conviction liability policy 100 may be designed to offer specific protection against the risk of third-party lawsuits and similar claims related to a mistaken conviction. For example, and without limitation, the insured may be a federal, state, or municipal government responsible for administering criminal justice. Liability policy payment typically may be made not to the insured, but rather to an exoneree who is a beneficiary to the insurance contract 110.

The liability policy may specify an insurance coverage amount 120 offered by an insurer as protection against a risk to the insured, and a premium amount 130 required by the insurer as consideration for the insurance coverage amount 120. The liability policy may specify a trigger event 110 for payout of coverage 120 as the overturning of a mistaken conviction for which the exoneree may choose to sue the insured.

Continuing to refer to FIG. 1, the liability coverage amount 120 defines the limits to which an insurer may financially cover mistaken conviction claims based on statutory compensation guidelines and/or on the liability insurer's three traditional duties: to defend the insured 121, to indemnify the insured 122, and to settle a reasonably clear claim against the insured 123. A liability policy 100 may operate effectively as indemnification insurance when the liability coverage amount 120 is arbitrarily set by the insurer or fixed by statutory compensation guidelines.

In more detail, still referring to the invention of FIG. 1, the insurer's duty to defend 121 may arise when an exoneree sues the insured and the insured, in turn, tenders defense of the claim to its liability insurer. For example, and without limitation, assuming the mistaken conviction claim is covered under the policy, the insurer may accept the claim and defend the case using legal counsel of its choosing. Alternatively, the policy may allow for the insurer to reimburse the insured for legal expenses incurred by the insured defending against the exoneree's claims.

Continuing to refer to FIG. 1, the insurer's duty to indemnify 122 may require payment of all sums for which the insured is liable, up to a mistaken conviction coverage amount limit 120 stated in the policy. For example, and without limitation, mistaken conviction insurance may indemnify injury liability 124 for injury by incarceration; and expense liability 125 for medical conditions resulting from incarceration, and for rewards paid to secure evidence leading to exoneration.

In more detail, and continuing to refer to FIG. 1, the insurer may have a duty to settle a mistaken conviction claim 123 against the insured so that the insured is not burdened with a judgment in excess of policy limits. For example, and without limitation, if the insurer decides the mistaken conviction claim is covered under the policy, the insured may commit resources to assist in achieving a settlement for the insured.

Continuing to refer to FIG. 1, the insurer may be required to payout compensation 129 to a mistakenly convicted beneficiary at a legislatively-mandated level. For example, and without limitation, an exoneree compensation statute may be state, federal, or foreign.

The liability premium amount 130, as shown in FIG. 1, may be an insured's payment offered as consideration for the insurer's protection against the peril of mistaken conviction. Payment of a premium 130 for an issued mistaken conviction insurance liability policy 100 may occur at, after, or in anticipation of sentencing. For example, and without limitation, payment of a premium amount 130 typically will not occur later than the date a mistaken conviction giving rise to a claim is overturned. Those skilled in the art will appreciate, however, that the premium may be paid at any time during the criminal prosecution process. Many examples of the different times that the premium may be paid and, as such, the time at which the mistaken conviction insurance liability policy 100 may be obtained are discussed in greater detail below.

Factors affecting the calculation of premium amount 130 may include coverage payout elections 131, premium payment elections 132, and trigger event likelihood 133. For example, and without limitation, coverage payout elections 131 may reflect a choice of payout in the form of a periodic annuity, a settlement installment, or a lump-sum payment. Premium payment elections 132 may reflect a choice of payment in the form of a single payment, flexible payments, and modal payments. Depending on the policy provisions of the insurance contract 110, the payout election 131 and payment election 132 may be made by the insurer, the insured, or the beneficiary. For example, and without limitation, a determination of trigger event likelihood 133 may be based on conviction variables such as the strength of evidence leading to the conviction, the selection of a jury trial versus a bench trial, the performance history of the court hearing the case, and the nature of the alleged crime. Alternatively, or in addition, trigger event likelihood 133 may be based on factors related to the convicted person, such as a prior criminal record, age upon conviction, and exposure to discrimination (for example, by race or gender).

Continuing to refer to FIG. 1, a liability policy contract 110 may include definitions of key policy terms, including “mistaken conviction,” “claim,” “coverage limit,” “insured,” “insurer,” and applicable “jurisdiction” for third party claims (state, federal, foreign).

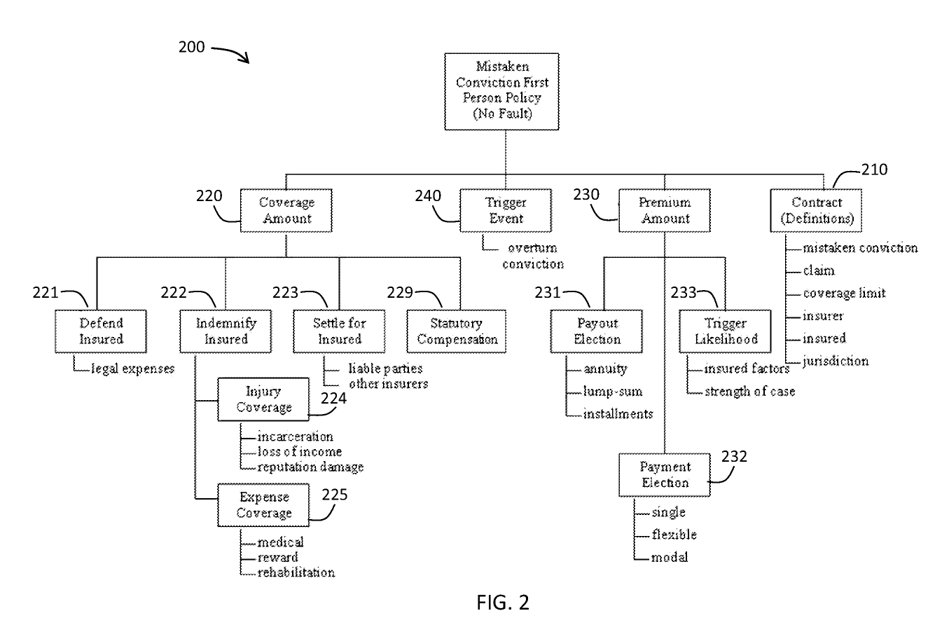

Referring now to FIG. 2, general characteristics of a first person policy embodiment are shown. A mistaken conviction first person policy 200 may be designed to offer no fault protection against the risk of an insured being mistakenly convicted of a crime. First person policy payment typically may provide an exoneree direct payment from the insurer with which the exoneree is insured by contract 210. This no fault insurance may eliminate the need for an insured exoneree to establish another's liability, or fault, through a civil lawsuit.

The first person policy 200 may specify an insurance coverage amount 220 offered by an insurer as protection against a risk to the insured, and a premium amount 230 required by the insurer as consideration for the insurance coverage amount 220. The first person policy may specify a trigger event 240 for payout of coverage 220 to be the overturning of a mistaken conviction for which the insured exoneree may seek compensation.

Continuing to refer to FIG. 2, the first person coverage amount 220 may define the limits to which an insurer may financially cover mistaken conviction claims by the insured based on statutory compensation guidelines and/or on the insurer's three traditional duties: to defend the insured 221, to indemnify the insured 222, and to settle a reasonably clear claim related to the insured 223. A first person policy 200 may operate effectively as indemnification insurance when the first person coverage amount 220 is arbitrarily set by the insurer or fixed by statutory compensation guidelines.

Still referring to the invention of FIG. 1, the insurer's duty to defend 221 may arise when a mistaken conviction claim is covered under the policy, and the insurer may offer to reimburse the insured for legal expenses. For example, and without limitation, such legal expenses may include those incurred while positing defense arguments during the sentencing phase, while proving the exoneree's innocence after the mistaken conviction, and while clearing the exoneree's criminal record after the conviction is overturned.

In more detail, and continuing to refer to FIG. 2, the insurer's duty to indemnify 222 may require the insurer provide compensation for all covered peri-conviction and post-conviction injuries and expenses experienced by the insured, up to a mistaken conviction coverage amount limit 220 stated in the policy contract 210. For example, and without limitation, mistaken conviction insurance 200 may cover injury damages 224 for incarceration, for loss of income while incarcerated (adjusted for inflation during the incarceration period), and for reputation damage from false media coverage and negative publicity. Also for example, and without limitation, a mistaken conviction policy 200 may cover expenses 225 for medical conditions resulting from incarceration, for rewards paid to secure evidence leading to exoneration, and for rehabilitation services related to job placement, retraining, and transition assistance.

Continuing to refer to FIG. 2, no fault insurance such as a mistaken conviction first person policy 200 is designed as a settlement alternative 223 to litigation. For example, and without limitation, after a no fault insurer remits a payout 220 to an exoneree, that insurer may elect to pursue reimbursement from liable parties and/or from those parties' liability insurers. In cases where wrongful conviction is present, the insurer may seek reimbursement from liable parties' Comprehensive General Liability insurers, Public Official Liability insurers, and/or Law Enforcement Liability insurers.

Continuing to refer to FIG. 2, the insurer may be required to payout compensation 229 to a mistakenly convicted person at a legislatively-mandated level. For example, and without limitation, an exoneree compensation statute may be state, federal, or foreign.

The first person premium amount 230, as shown in FIG. 2, may be an insured's payment offered as consideration for the insurer's protection against the peril of mistaken conviction. Payment of a premium 230 for an issued mistaken conviction insurance no fault policy 200 may occur at, after, or in anticipation of sentencing. For example, and without limitation, payment of a premium amount 230 typically will not occur later than the date a mistaken conviction giving rise to a claim is overturned.

Factors affecting the calculation of premium amount 230 may include coverage payout elections 231, premium payment elections 232, and trigger event likelihood 233. For example, and without limitation, coverage payout elections 231 may reflect a choice of payout in the form of a periodic annuity, a settlement installment, or a lump-sum payment. Premium payment elections 232 may reflect a choice of payment in the form of a single payment, flexible payments, and modal payments. Depending on the policy provisions of the insurance contract 210, the payout election 231 and payment election 232 may be made by the insurer or the insured. For example, and without limitation, a determination of trigger event likelihood 233 may be based on conviction variables such as the strength of evidence leading to the conviction, the selection of a jury trial versus a bench trial, the performance history of the court hearing the case, and the nature of the alleged crime. Alternatively, or in addition, trigger event likelihood 233 may be based on factors related to the convicted person, such as an prior criminal record, age upon conviction, and exposure to discrimination (for example, by race or gender).

Continuing to refer to FIG. 2, a first person policy contract 210 may include definitions of key policy terms, including “mistaken conviction,” “claim,” “coverage limit,” “insured,” “insurer,” and applicable “jurisdiction” for third party claims (state, federal, foreign).

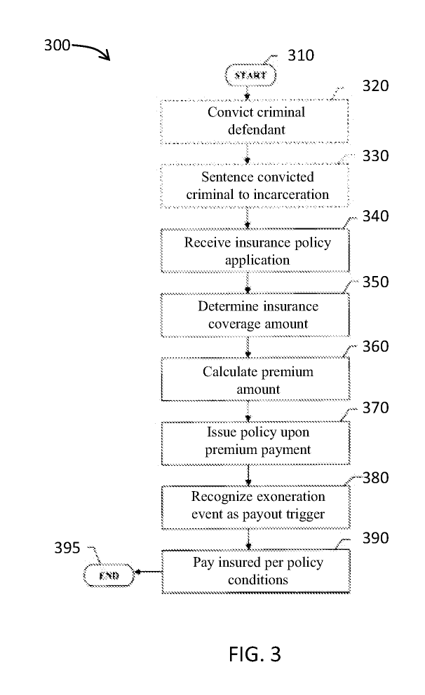

Referring now to flowchart 300 of FIG. 3, the operation of a method of doing business for assessing, pricing, and provisioning a mistaken conviction insurance product 100 will be discussed. The following illustrative embodiment is included to provide clarity for one operational method that may be included within the scope of the present invention. A person of skill in the art will appreciate additional operations that may be included in assessing, pricing, and provisioning a mistaken conviction insurance product 100 of the present invention, which are intended to be included herein and without limitation.

From the start, the operation may begin at Block 310, where a court of law may convict a defendant of a crime 320. For example, and without limitation, the court may be a federal court, a state court, or a municipal court responsible for administering criminal justice. As a modality of punishment and rehabilitation, the court may sentence the convicted person to incarceration 330 for the crime. At Block 340, an insurer may receive an application for a mistaken conviction insurance policy to manage the risk of the convicted person later being exonerated. In one embodiment, for example and without limitation, the application may be a first person policy 200 application submitted by or on behalf of the person convicted. In another embodiment, for example and without limitation, the application may be a liability policy 100 application submitted by the government institution under which the court is organized. At Block 350 the insurer may determine the amount of coverage to be paid in the event the person convicted is subsequently exonerated. For example, and without limitation, this coverage amount may be dictated by the insurer without input from the insured. Alternatively, the insurance product may be flexible in its policy terms to allow a variety of coverage options from which an insured may select. At Block 360, the insurer may calculate a premium to be paid as consideration for the coverage amount. At Block 370, the insurer may issues the mistaken conviction policy, typically starting the policy period upon receipt of a policy premium payment. Should the convicted person be exonerated sometime after sentencing, the insurer may recognize the exoneration event as a trigger 380 to payout the coverage amount. At Block 390, the insurer may pay the insured the coverage amount in keeping with the policy provisions, at which point the method ends 395.

Generally following the process illustrated by the flowchart 300 in FIG. 3, several variants of methods of doing business are possible. For example, and without limitation, a mistaken conviction insurance policy 100, 200 of the present invention may be in the form of a single premium payment 370 (example, $36) required by an insurer (example: a state insurance pool) as consideration for a coverage amount 350 (example: statutorily set at $100,000 per year of incarceration) to be paid in settlement installments 131, 231 (example: $75,000 annually until payout of the coverage amount is complete), with payout of the coverage amount 390 triggered by the overturning of an incarcerated person's mistaken conviction 380.

For example, and without limitation, an application for mistaken conviction insurance may be submitted to an insurer 340 at some point during the criminal prosecution process, such as at sentencing, at trial conclusion, at trial initiation, at the close of discovery, at a preliminary hearing, at a bail hearing, or at the time of arrest. The risk of exoneration as a trigger of payout may vary and, therefore, may put upward or downward pressure on the premium amount calculation 360 depending on the stage of the criminal process at which the mistaken conviction insurance policy is initiated 370. In one embodiment, upward pressure on premium pricing may occur if a either a liability policy 100 or first person policy 200 is purchased at the time of arrest, as very few facts may yet be available from which to predict the ultimate outcome of the criminal proceedings against the person arrested. At the same time, broadening the pool of mistaken conviction insurance program participants to include not only the convicted but also the charged may put downward pressure on the price of mistaken conviction insurance premiums for all.

For example, and without limitation, establishing the insurance coverage amount 350 may be a simple as dictating a fixed amount per year of incarceration experienced by any exoneree (example: statutory compensation) or as complex as calculating the damages and expenses related to the mistaken conviction of an individual exoneree (example: loss of potential earnings while incarcerated). Allowing the coverage amount to be tailored may put upward or downward pressure on the premium amount calculation 360 depending on the extent to which the mistaken conviction insurance policy may expose the insurer to a larger potential payout 390. In one embodiment, upward pressure on premium prices may occur if a either a liability policy 100 or first person policy 200 may provide for a coverage amount 120, 220 large enough to cover compensatory damages 124, 224 for a convicted person with higher earning potential. At the same time, limiting the coverage amount 120, 220 to fit the risked cost of compensating an exoneree with low earning potential may put downward pressure on the price of mistaken conviction insurance premiums 360 for persons of limited means. Downward pressure on premiums may result for people with a lesser chance of an exoneration based on factors such as the age and health status of the convicted person at the time of conviction. Other changed circumstances that may impact the determination of the calculation amount 360 may include inflation and deflation.

For example, and without limitation, payment of premiums 370 may be a simple as single payment made to an insurer at the issuance of the mistaken conviction insurance policy (example: indemnification insurance purchased by a convicted criminal) or as complex as a recurring periodic (e.g., monthly, semi-annually or annually) payment of premiums to an insurer (example: a municipal government funding a mistaken conviction insurance liability policy to cover its criminal court's entire caseload). The cost to administer other than single payments may put upward pressure on premium prices not only due to the cost to administer multiple payments, but also due to less than the entire annual premium being available to the insurer during a policy year. Conversely, single payments may put downward pressure on premium prices.

For example, and without limitation, potential payers of the mistaken conviction insurance first person policy premium 370 may be the convicted person, that person's family or personal sponsor (private funds), and/or an advocacy group (donated funds and grants). Such a payment model may advantageously spread the risk of mistakenly convicting and incarcerating the innocent among the whole of defendants convicted of crimes in a municipality, a state, or the entire nation. Also for example, and without limitation, potential payers of the mistaken conviction insurance liability policy premium 370 may be state or local governments (taxpayer funding), and/or officers of the court (contributions by the involved prosecutor, defense attorney, and presiding judge). Such a payment model may advantageously spread the risk of mistakenly convicting and incarcerating the innocent among the whole of those responsible for ensuring justice is done. Also, officers of the court who are members of the bar may be able to report mistaken conviction insurance premium payments as financial support for organizations that provide legal services to persons of limited means.

For example, and without limitation, a mistaken conviction insurance policy may be sold to prospective participants in the usual ways for selling prize indemnity insurance. More specifically, just as prize indemnity insurance allows a promoter to offer a large, risk-free, contingent prize (example: $1 million hole-in-one for golfers) for only a fraction of the cost of the prize, mistaken conviction insurance may allow a responsible government entity or official to offer generous compensation to exonerees at an extremely low cost. Alternatively, a mistaken conviction insurance point of sale may be established in a court room or other official facility where criminal justice proceedings take place. For example, a mobile application may accept mistaken conviction policy applications from users present at the conclusion of a sentencing hearing. The mobile application may return a premium quote based on actuarial information collected regarding the convicted person and the conviction proceedings. For example, and without limitation, characteristics of the responsible court, such as the trial records of the court's attorneys and the number of cases tried in the pertinent past, may be weighted and analyzed by the automated system for purposes of calculating a premium quote. Payment of a premium using a credit card or a pre-established account may be processed by the mobile application, and confirmation of the issuance of mistaken conviction insurance may be returned by the insurer through the mobile application.

For example, and without limitation, a mistaken conviction insurance policy may be offered not only to those with active cases in the criminal justice system, but to the general public by being combined with disability or life insurance. In one embodiment, the mistaken conviction insurance policy may be offered or provided as an employee benefit. In another embodiment, mistaken conviction insurance may be coordinated with a retirement plan or plans so that if the insured is not convicted of a crime and sentenced to incarceration during a predetermined period, the premiums (or a portion thereof) may be refunded to the insured.

For example, and without limitation, once determined and collected, at least a portion of each premium amount will be invested by the insurer in appropriate investments. Such investments are well known to those of skill in the art, but generally may include, stocks, bonds, bank accounts, fixed income investments, and venture capital investment. Once invested, the funds collected as premium payments may grow for eventual distribution either to participants or to owners of the insurer's company.

For example, and without limitation, in order to collect on a mistaken conviction insurance policy 390, satisfactory proof of exoneration 380 (example: certified copies of court documents) may need to be provided to the insurer, or otherwise collected by the insurance company, and certifications may need to be made to ensure that the convicted is actually exonerated of the crime before payment was made. If an insured is somehow convicted of multiple crimes based on conduct occurring in the same transaction, an insurer may require a refund of at least some of multiple coverage amount payments made 390 for a single incarceration, although this refund is not necessary in all embodiments and circumstances.

For example, and without limitation, payout of a coverage amount 390 may be a simple as single lump-sum payout made by an insurer upon approval of a claim or as complex as a recurring periodic (e.g., installment, annuity) payout by an insurer to an exoneree). The cost to administer other than single payouts may put upward pressure on premium prices due to the cost to administer multiple payouts. At the same time, spreading payout of a coverage amount 120, 220 over time may put downward pressure on premium prices due to cash flow benefits to the insurer. Also, payouts made over time on behalf of an exoneree (example: to the child or spouse of the exoneree), with few or no lump sum payments, may decrease the impetus for any fraud against the insurer. Further, policy payouts may be in the form of financial support for the exoneree and his dependents (example: pay for child support, alimony, children's or spouse's education, maintenance of health and life insurance premiums), or may also be made to educate or re-train the exoneree or his dependents for reassimilation into society.

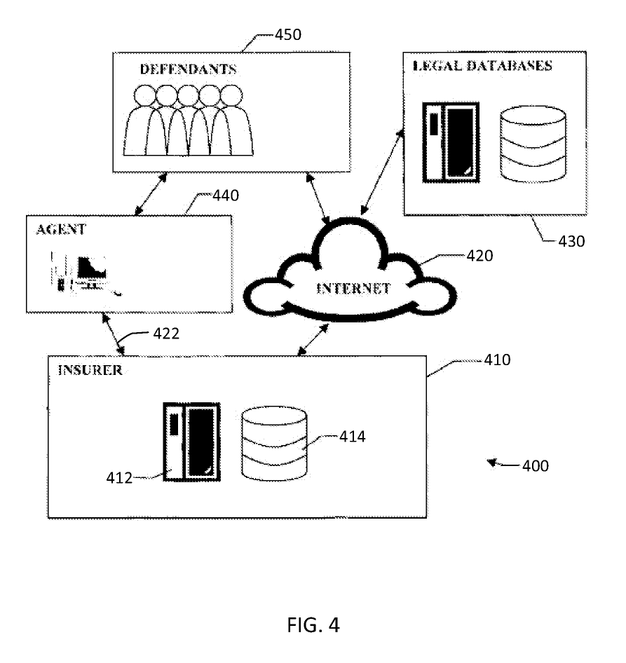

Referring now to FIG. 4, a system 400 for assessing, pricing, and provisioning mistaken conviction insurance according to an embodiment of the present invention is now described in greater detail. The system 400 may include an insurer server 410 that may be configured to be connected with a network 420, such as the Internet. For example, and without limitation, the network 420 may also include a mobile network that may be any type of cellular network device, including GSM, GPRS, CDMA, EV-DO, EDGE, 3G, DECT, OFDMA, WIMAX, and LTE communication devices. These and other communication standards permitting connection to a network 420, such as the Internet, are included within the invention.

The insurer server 410 may include a central processing unit 412 and an insurer database 414. The insurer database 414 may be configured to support storage and retrieval of mistaken conviction insurance policy information. In one embodiment of the present invention, actuarial information related to mistaken conviction risk management may be accessed from legal databases 430 and other sources to which an insurer has access, for example, through the Internet. Accessed information may be recorded in the insurer database 414 for subsequent automated analysis using instructions processed by the central processing unit 412.

From an agent client 440, a user may service mistaken conviction insurance policy applications submitted by or on behalf of criminal defendants 450, or by government entities under which a court hearing a criminal case is organized. A user may manage or otherwise manipulate mistaken conviction insurance information in the insurer database 414 using a system interface 422 to interact with the insurer server 410. For example, and without limitation, a local area network (LAN) may support communication between the agent client 440 and the insurer server 410.

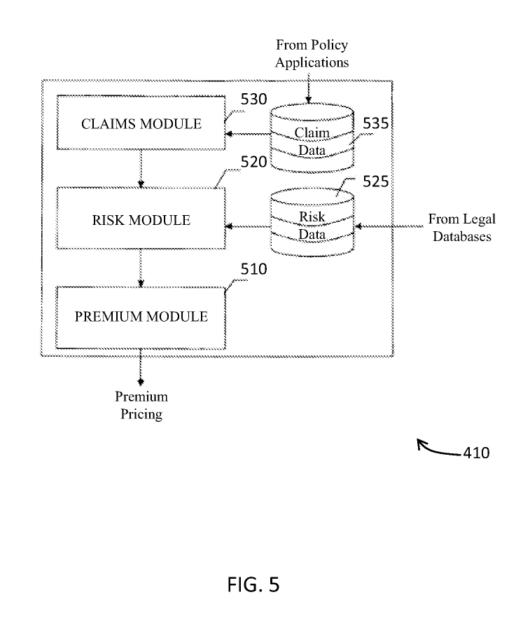

Referring to FIG. 5, an insurer server 410 illustrates one embodiment of an insurer server that may be used to provide mistaken conviction insurance. For example, the method 300 of FIG. 3 may be implemented within the insurer server 410. In the present example, the insurer server 410 includes a number of components to provide information to a user and to receive and process input from the user. The insurer server 410 may include executable actuarial instructions in the form of a premium module 510, a risk module 520, and a claims module 530. These modules may utilize information stored in a data store that may contain risk data 525 and claim data 535. The actuarial instructions and the data store may be used to determine an actuarial class for a policy applicant as well as an associated premium price.

It is understood that not every applicant utilizing the systems and methods disclosed herein will qualify for mistaken conviction insurance coverage. For example, those who have been found to have intentionally confessed or staged a conviction may not qualify for coverage. In some embodiments, persons convicted in both federal and state criminal courts for different crimes based on the same offensive action may also be disqualified from collecting from two policies for incarceration by concurrent sentences. Those skilled in the art will also recognize other risk factors, circumstances, and legal considerations that may disqualify a client from obtaining coverage utilizing the systems and methods disclosed herein.

It is further understood that, while the above embodiments do not rely on audits or verification, various steps may be implemented to protect against fraud using, for example, candidate screening at the time of purchase, record audits at the time of a claim, and/or national claim screening at the time of a claim. Some or all of these approaches may be implemented in the examples described above, including the insurer server 410.

Some circumstances may lead an insurer utilizing the systems and methods of the present disclosure to require a live representative or agent to evaluate particular cases. These cases may fall outside the ambit of the automated systems and methods disclosed herein, but insurance may ultimately be provided following review. In such cases, the information obtained by the automated systems and methods disclosed herein may be used for the evaluation. In other embodiments, the information obtained may be supplemented or replaced by additional information obtained by the live representative or agent. If insurance coverage is granted for such exceptional cases, the customer may be required to continue to deal with the live agent or may be returned to the automated systems and methods described herein.

Embodiments of the present invention are described herein in the context of a system of computers, servers, and software. Those of ordinary skill in the art will realize that the following embodiments of the present invention are only illustrative and are not intended to be limiting in any way. Other embodiments of the present invention will readily suggest themselves to such skilled persons having the benefit of this disclosure.

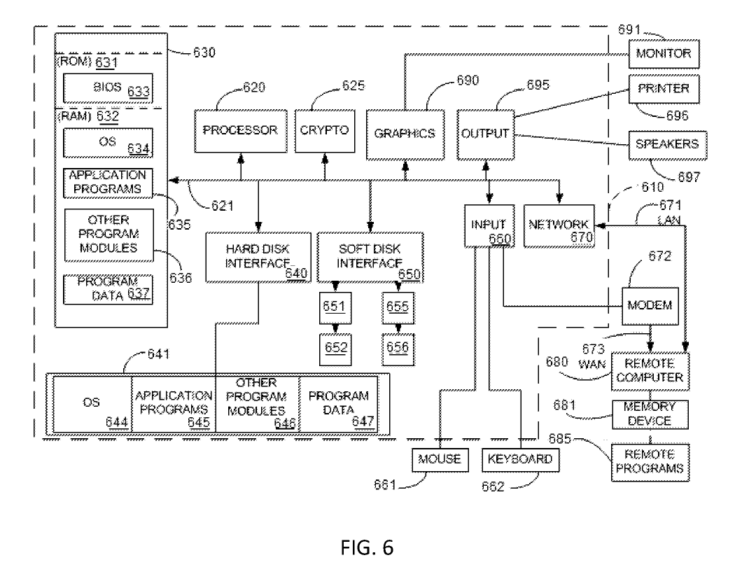

A skilled artisan will note that one or more of the aspects of the present invention may be performed on a computing device, including mobile devices. The skilled artisan will also note that a computing device may be understood to be any device having a processor, memory unit, input, and output. This may include, but is not intended to be limited to, cellular phones, smart phones, tablet personal computers (PCs), laptop computers, desktop computers, personal digital assistants (PDAs), etc. FIG. 6 illustrates a model computing device in the form of a computer 610, which is capable of performing one or more computer-implemented steps in practicing the method aspects of the present invention. Components of the computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI).

The computer 610 may also include a cryptographic unit 625. Briefly, the cryptographic unit 625 has a calculation function that may be used to verify digital signatures, calculate hashes, digitally sign hash values, and encrypt or decrypt data. The cryptographic unit 625 may also have a protected memory for storing keys and other secret data. In other embodiments, the functions of the cryptographic unit may be instantiated in software and run via the operating system.

A computer 610 typically includes a variety of computer readable media. Computer readable media can be any available media that can be accessed by a computer 610 and includes both volatile and nonvolatile media, removable and non-removable media. By way of example, and not limitation, computer readable media may include computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates an operating system (OS) 634, application programs 635, other program modules 636, and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives, and their associated computer storage media discussed above and illustrated in FIG. 6, provide storage of computer readable instructions, data structures, program modules and other data for the computer 610. In FIG. 6, for example, hard disk drive 641 is illustrated as storing an OS 644, application programs 645, other program modules 646, and program data 647. Note that these components can either be the same as or different from OS 634, application programs 635, other program modules 636, and program data 637. The OS 644, application programs 645, other program modules 646, and program data 647 are given different numbers here to illustrate that, at a minimum, they may be different copies. A user may enter commands and information into the computer 610 through input devices such as a keyboard 662 and cursor control device 661, commonly referred to as a mouse, trackball or touch pad. Other input devices (not shown) may include a microphone, joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a graphics controller 690. In addition to the monitor, computers may also include other peripheral output devices such as speakers 697 and printer 696, which may be connected through an output peripheral interface 695.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 6 illustrates remote application programs 685 as residing on memory device 681.

The communications connections 670 and 672 allow the device to communicate with other devices. The communications connections 670 and 672 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

In accordance with embodiments of the present invention, the components, process steps, and/or data structures may be implemented using various types of operating systems, computing platforms, computer programs, and/or general purpose machines. In addition, after having the benefit of this disclosure, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

The computer program, according to an embodiment of the present invention, is a computerized system that requires the performance of one or more steps to be performed on or in association with a computerized device, such as, but not limited to, a server, a computer (i.e., desktop computer, laptop computer, netbook, or any machine having a processor), a dumb terminal that provides an interface with a computer or server, a personal digital assistant, mobile communications device, such as an cell phone, smart phone, or other similar device that provides computer or quasi-computer functionality, a mobile reader, such as an electronic document viewer, which provides reader functionality that may be enabled, through either internal components or connecting to an external computer, server, or global communications network (such as the Internet), to take direction from or engage in processes which are then delivered to the mobile reader. It should be readily apparent to those of skill in the art, after reviewing the materials disclosed herein, that other types of devices, individually or in conjunction with an overarching architecture, associated with an internal or external system, may be utilized to provide the “computerized” environment necessary for the at least one process step to be carried out in a machine/system/digital environment. It should be noted that the method aspects of the present invention are preferably computer-implemented methods and, more particularly, at least one step is preferably carried out using a computerized device.

While the preceding description shows and describes one or more embodiments, it will be understood by those skilled in the art that various changes in form and detail may be made therein without departing from the spirit and scope of the present disclosure. For example, various steps of the described methods may be executed in a different order or executed sequentially, combined, further divided, replaced with alternate steps, or removed entirely. In addition, various functions illustrated in the methods or described elsewhere in the disclosure may be combined to provide additional and/or alternate functions. As described, some or all of the steps of each method may be implemented in the form of computer executable software instructions. Furthermore, the instructions may be located on a server that is accessible to many different clients, may be located on a single computer that is available to a user, or may be located at different locations. Therefore, the claims should be interpreted in a broad manner, consistent with the present disclosure. While various embodiments have been described for purposes of this disclosure, numerous changes and modifications will be apparent to those of ordinary skill in the art. Such changes and modifications are encompassed within the spirit of this invention as defined by the claims.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

What is claimed is:

1. An insurance product comprising:
an insurance coverage amount offered by an insurer;
a premium amount required by the insurer as consideration for the insurance coverage amount; and
a trigger event recognized by the insurer for payout of the insurance coverage amount, the trigger event comprising an overturning of a mistaken conviction.

2. An insurance product according to claim 1 wherein the premium amount is based at least in part on a payout election, wherein the payout election comprises at least one payout type selected from the group consisting of a lump-sum payout, an installment payout, and a periodic annuity payout.

3. An insurance product according to claim 1 wherein the premium amount is based at least in part on a payment election, wherein the payment election comprises at least one payment type selected from the group consisting of a single payment, a flexible payment, and a modal payment.

4. An insurance product according to claim 1 wherein the premium amount is based at least in part on a risk of the trigger event occurring, wherein the risk of the trigger event occurring is based on at least one actuarial criterion selected from the group consisting of a convicted factor and a conviction factor.

5. An insurance product according to claim 4 wherein the actuarial criterion is a convicted factor selected from the group consisting of prior criminal record, age upon conviction, convicted gender, and convicted race.

6. An insurance product according to claim 4 wherein the actuarial criterion is a conviction factor selected from the group consisting of strength of evidence, trial type, trial forum, and nature of the alleged crime.

7. An insurance product according to claim 1 wherein the premium amount is based at least in part on the insurance coverage amount, wherein the insurance coverage amount is based on at least one insurer obligation type selected from the group consisting of a duty to defend an insured, a duty to indemnify the insured, a duty to settle for the insured, and an obligation to comply with statutory compensation guidelines.

8. An insurance product according to claim 7 wherein the duty to defend an insured comprises at least one of a duty to pay to defend the insured against a liability claim by an exoneree and a duty to reimburse the insured for legal defense expenses stemming from a liability claim by an exoneree.

9. An insurance product according to claim 7 wherein the duty to settle for the insured comprises a duty to pay to settle a liability claim by an exoneree.

10. An insurance product according to claim 7 wherein the duty to indemnify the insured comprises at least one of a duty to indemnify liability of the insured for one or more injuries to an exoneree and a duty to indemnify liability of the insured for one or more expenses borne by an exoneree.

11. An insurance product according to claim 10 wherein the one or more injuries comprise incarceration of an exoneree.

12. An insurance product according to claim 10 wherein the one or more expenses comprise at least one of a cost to treat a medical condition resulting from incarceration of an exoneree and a cost to reward the securing of evidence leading to overturning the conviction of an exoneree.

13. An insurance product according to claim 7 wherein the duty to defend the insured comprises a duty to reimburse an exoneree for legal defense expenses.

14. An insurance product according to claim 7 wherein the duty to indemnify the insured comprises at least one of a duty to payout coverage for damages resulting from one or more injuries to an exoneree and a duty to payout coverage for damages resulting from one or more expenses borne by an exoneree.

15. An insurance product according to claim 14 wherein the one or more injuries comprises at least one of incarceration of the exoneree, loss of income by the exoneree, and damage to the reputation of the exoneree.

16. An insurance product according to claim 14 wherein the one or more expenses comprises at least one of a cost to treat a medical condition resulting from incarceration of an exoneree, a cost to reward the securing of evidence leading to overturning the conviction of an exoneree, and a cost for rehabilitation services.

17. An insurance product according to claim 14 wherein the duty to settle for the insured comprises an agreement by an insurer to seek reimbursement for payout to an exoneree from at least one of a liable party and an insurer of the liable party.

18. A method of compensating an exoneree for mistaken conviction, the method comprising:
offering to sell a mistaken conviction insurance product, the mistaken conviction insurance product including
an insurance coverage amount,
a premium amount required as consideration for the insurance coverage amount, and
a trigger event recognized for a payout of the insurance coverage amount, the trigger event comprising an overturning of a mistaken conviction; and
issuing the mistaken conviction insurance product upon receipt of the premium amount.

19. A method according to claim 18 further comprising:
receiving a payout election, the payout election comprising at least one payout type selected from the group consisting of a lump-sum payout, an installment payout, and a periodic annuity payout; and
calculating the premium amount based at least in part on the payout election.

20. A method according to claim 18 further comprising:
receiving a payment election, the payment election comprising at least one payment type selected from the group consisting of a single payment, a flexible payment, and a modal payment; and
calculating the premium amount based at least in part on the payment election.

21. A method according to claim 18 further comprising:
assessing a risk of the trigger event occurring, the risk of the trigger event occurring being based on at least one actuarial criterion selected from the group consisting of a convicted factor and a conviction factor; and
calculating the premium amount based at least in part on the risk of the trigger event occurring.

22. A method according to claim 18 wherein the actuarial criterion is a convicted factor selected from the group consisting of prior criminal record, age upon conviction, convicted gender, and convicted race.

23. A method according to claim 18 wherein the actuarial criterion is a conviction factor selected from the group consisting of strength of evidence, trial type, trial forum, and nature of the alleged crime.

24. A method according to claim 18 further comprising:
determining an insurer obligation, the insurer obligation being at least one of an insurer obligation type selected from the group consisting of a duty to defend an insured, a duty to indemnify an insured, a duty to settle for an insured, and an obligation to comply with statutory compensation guidelines; and
calculating the premium amount based at least in part on the insurer obligation.

25. A method according to claim 18 further comprising paying the insurance coverage amount as a consequence of the trigger event occurring.

26. A computer system for providing mistaken conviction insurance comprising:
a computer processor; and
a computer memory accessible to the computer processor;
wherein the computer memory comprises a plurality of instructions which, when executed by the computer processor, perform a method, the method comprising:
offering to sell a mistaken conviction insurance product, the mistaken conviction insurance product comprising
an insurance coverage amount,
a premium amount required as consideration for the insurance coverage amount, and
a trigger event recognized for a payout of the insurance coverage amount, the trigger event comprising an overturning of a mistaken conviction; and
issuing the mistaken conviction insurance product upon receipt of the premium amount.

27. A computer system according to claim 26 wherein the method further comprises:
receiving a payout election, the payout election comprising at least one payout type selected from the group consisting of a lump-sum payout, an installment payout, and a periodic annuity payout; and
calculating the premium amount based at least in part on the payout election.

28. A computer system according to claim 26 wherein the method further comprises:
receiving a payment election, the payment election comprising at least one payment type selected from the group consisting of a single payment, a flexible payment, and a modal payment; and
calculating the premium amount based at least in part on the payment election.

29. A computer system according to claim 26 wherein the method further comprises:
assessing a risk of the trigger event occurring, the risk of the trigger event occurring comprising at least one actuarial criterion selected from the group consisting of a convicted factor and a conviction factor; and
calculating the premium amount based at least in part on the risk of the trigger event occurring.

30. A computer system according to claim 29 wherein the actuarial criterion is a convicted factor selected from the group consisting of prior criminal record, age upon conviction, convicted gender, and convicted race.

31. A computer system according to claim 29 wherein the actuarial criterion is a conviction factor selected from the group consisting of strength of evidence, trial type, trial forum, and nature of the alleged crime.

32. A computer system according to claim 26 wherein the method further comprises:
determining an insurer obligation, the insurer obligation being at least one insurer obligation type selected from the group consisting of a duty to defend an insured, a duty to indemnify an insured, a duty to settle for an insured, and an obligation to comply with statutory compensation guidelines; and
calculating the premium amount based at least in part on the insurer obligation.

33. A computer system according to claim 26 wherein the method further comprises paying the insurance coverage amount as a consequence of the trigger event occurring.
